(19) United States
(12) Patent Application Publication
(10) Pub. No.: US 2015/0121547 A1
(43) Pub. Date: Apr. 30, 2015

(54) System and method for peer-to-peer lending of digital content within an expanded social network

(71) Applicant: Usman Hafeez, Chicago, IL (US)

(72) Inventor: Usman Hafeez, Chicago, IL (US)

(21) Appl. No.: 14/064,902

(22) Filed: Oct. 28, 2013

(51) Int. Cl. G06F 21/10; G06F 17/24

(52) U.S. Cl. CPC G06F 21/10; G06F 17/241
USPC 726/28

(57) ABSTRACT

The invention is directed toward a system and method for peer-to-peer lending of digital content within an expanded social network. The invention provides for systems and methods for the searching of users with a particular digital content, displaying the digital content owned by users within a borrowers' expanded social network, requesting of the loaning of the digital content from lender(s), and the tracking of loaned digital content, either connected to a network or via in-person transfer of digital content. In addition, embodiments of the present invention provide systems and methods to allow for the borrower to add and share annotations (such as notes or multimedia annotations) to the digital content. The system comprises a client computer connected to a server computer with a database through the internet, an interface software module, a social networking software module, a content management software module, and a user annotation software module.

### FIELD OF THE INVENTION

The present invention generally relates to systems and methods for lending digital content and more specifically to peer-to-peer lending of digital content within an expanded social network. Further, embodiments of the present invention provide systems and methods to allow for the searching of users with a particular digital content, displaying the digital content owned by users within an borrowers' expanded social network, requesting of the loaning of the digital content from lender(s), and the tracking of loaned digital content, either connected to a network or via in-person transfer of digital content. In addition, embodiments of the present invention provide systems and methods to allow for the borrower to add and share annotations (such as notes or multimedia annotations) to the digital content.

### BACKGROUND OF THE INVENTION

The use of digital books, or ebooks, has grown to a phenomenal level. Digital devices for the display of ebooks are abundant and used throughout society. With the ease of copying and distributing digital files, authors and publishers have become restrictive of the permissions granted to users of electronic files for legal reasons. Technological restrictions known as Digital Rights Management (DRM) were developed and put in place to limit and restrict the illegal dissemination and distribution of electronic files. Most DRM systems prevent copying of electronic files or the viewing of electronic files on unapproved devices.

Library based ebook lending systems are known in the art. Users may request a digital ebook from a library digital storage. When a user checks out an ebook from a library, the user gets a digital copy of the ebook for a specified period of time. When that user has the ebook checked out, other users are unable to check out the ebook. Thus there is only one digital copy of the ebook. When the specified period of time has elapsed, the digital ebook automatically returns to the library for other users to check out. Peer-to-peer sharing of digital ebooks are also disclosed in the prior art. U.S. Patent Publication US 2012/0179753 describes a system and method of peer-to-peer ebook lending and borrowing. These systems are limited in that the lender gives up master control of the ebook during the loan period. The prior art teaches that a borrower may return a digital ebook prior to the expiration of a predetermined time period but the prior art does not handle a situation where the lender desires or requires the ebook prior to the expiration of the predetermined time period. What is needed is a system where the lender retains master control over the ebook during the lending process and has the ability to recall the ebook prior to the expiration of the predetermined loan period. In addition, the prior art is limited in that it does not permit users of the systems to create, edit, or share notes or annotations concerning any digital ebook. What is needed is a system where a lender of an ebook may record notes and annotations on the ebook and lend the ebook to a borrower with the notes and annotations intact.

### SUMMARY OF THE INVENTION

It is an aspect of the present invention to provide a system and method for peer-to-peer lending of digital content items by a user with others either within the user's social network or contacts, a certain number of degrees of separation from the user, or in person sharing. The digital content is shared such that the digital content is controlled by the owner, or lender, of the digital content and is made available to only one user, lender or borrower, to use the digital con it at a given time. The borrower may initiate a loan request for digital content owned by the owner. Likewise, the owner may initiate a loan offer of digital content owned.

In the preferred embodiment the borrower initiates the request for digital content owned by the lender. The lender can review the requests from borrowers and choose to lend the digital content to only one borrower, who will receive notification that the digital content is available for use. The digital content itself can reside on the lender's device or on a remote server. The permission to lend digital content resides solely with the owner of the digital file. A borrower of a digital file may not lend the digital file to other users. The server controls who has access to the digital content at a given time, with ultimate control residing with the owner of the digital content.

The borrower may initiate the request to be lent the digital content item(s). Through the server, the borrower can search for a particular digital content item and view who in the user's social network has that particular digital content that can be lent, or a similar digital item. The borrower can then send a request through the server. The borrower can also send a request by copying a system generated message containing a URL and send that message via an established communication means, such as email, Facebook, twitter, etc. When sent through the system, the server informs the proposed lender that there is a borrow request waiting for them, from whom the borrow request originates, the digital item being requested, and the length of time for which the item is being requested.

The loan request and the transfer of the digital content can occur over a network, such as the internet or LAN. The request and transfer of the digital content can also occur directly from client device to client device via Bluetooth, Near Field Communication, WiFi, or other means that allows a device to communicate with another device that is within close proximity to the first device. The digital content can be viewed on any computing device, including but are not limited to PCs, tablets, smartphones, and other computing devices that can transfer data, connect to a network, and display content for a user's consumption.

The lender views the loan request on a local client device. When the lender accepts a particular borrower's request, the server is informed of 1) the lender, 2) the digital item to be lent, 3) the borrower, and 4) the length of time for which the digital item is requested. The server processes the request and grants access to the loaned digital item to the borrower. The server sends a message to the borrower informing them that their loan request has been accepted and that the borrower now has access to the digital content.

When receiving a request for lending an eBook, a user will be presented with information to assist with determining to whom to lend the digital content item. For instance, the proposed borrower may be part of the lender's class, or school, or within their social network. Conversely, the borrower may be many degrees of separation and may be someone the lender has never met nor has an immediate connection to. This information is valuable, in the cases when the user is presented with multiple requests for borrowing a digital content item. In this embodiment, the system will rank the requests coming from the potential borrowers based on degrees of separation, frequency of communication, past lending/borrowing, class/school/degree affiliation, and other pertinent information relevant to ranking the requests received.

When the length of time for borrowing the item has nearly ended, the server informs the borrower and lender that the requested borrowing time is nearly over, along with the amount of time remaining. When the amount of time has elapsed, the server can either automatically remove access to the digital content from the borrower, or allow access until the lender purposely recalls the digital content item. Even if the borrower is within the length of time they originally requested from the lender, the lender can recall the digital content at any time without the consent of the borrower.

In the preferred embodiment of the invention, a user can borrow from, or lend to, other users who are in an expanded social network. A user can request to borrow a digital item from another user who is a certain degree of separation away, such as a “friend of a friend” or a “friend of a friend of a friend.” The lender may choose to only lend to people within their immediate circle of their social network (1 degree of separation), and may specify to the system that he will only lend to people within that network. In the preferred embodiment, if a user grants permission to users within “x” degrees of separation to borrow digital items owned by that user, then the system will permit the user to borrow digital items from users within that same degree of separation. This presents an incentive to users to expand the degree of separation to find an ebook.

Besides having loan requests initiated only by a borrower, the lender may likewise initiate a loan offer and lend digital content to another user. The lender may search for a user within the lender's expanded social network to lend an item to. After the borrower accepts the loan offer the digital content is transferred to the borrower. The process of managing the digital item is the same otherwise.

The system also allows users to add digital annotations to digital content. The digital annotations may include, but are not limited to, comments, notes, references to additional study materials (such as a class syllabus), links to videos/images/audio/websites or other materials that better explain a concept within the eBook, and other such content which is added in the course of using the digital content item. All such content is saved to the server, and can be made available to another user who has purchased/rented/been lent a copy of the eBook. If the borrower purchases a copy of the digital content item, then the borrower can download all the additional digital annotations added to the borrowed digital item by another user to the digital content item purchased by the borrower.

In another embodiment of the system, the borrower, once access to the digital item has been removed, can be presented with the option to purchase the digital content item. If the borrower purchases the digital content item then the borrower can continue to use the digital content at the same point where access was taken away from the borrower.

For browser-based access, a user can utilize web pages to view the content. The only copies of the digital content item are the one stored on the server computer in the cloud and the one on the lender's local client device. The owner of the eBook can grant access to a borrower through the system, or directly from device to device using Bluetooth or NFC. If the borrower is using browser-based access to the digital content, then the borrower's devices need to be connected to a communication network (i.e. the internet) in order to use the digital content item.

Alternatively, there may be non-browser based access to the digital content. A lender can have the actual digital content item stored on their local client device. A copy is stored on the server, available only to the owner of the digital content item. When the owner makes the digital content item available to a borrower, the borrower may download a copy of the digital content item onto the borrower's local client device. Along with the copy of the digital content item what is also downloaded is the lender's identification, the date of lending, and the length of time the digital content item is lent (if a time limit is given). In this way a borrower who has the digital content item can view it even when off-line.

The system tracks the DRM of the digital content. If the ebook has no DRM then the system assumes that the ebook is in the public domain. Otherwise, the DRM license is transferred from the lender to the borrower during the lending period, preventing unauthorized copying of the ebook. The owner (lender) can take back the eBook at any time in order to use it or to lend it to another borrower. If the owner opens the eBook that was lent to the borrower, the owner has immediate access and the borrower is immediately denied access to the eBook.

A borrowed digital content item is lent to a borrower for only as long as the lender chooses. Whenever the borrower opens the lent eBook in a non-browser setting, there is a check request sent to the server first to establish if the borrower still to have access to the lent item. If the server returns that the item is still available to the borrower, the borrower is able to continue to use the eBook. If, on the other and, the server sends a reply that the item has been denied to the borrower, the borrower will not be able to access the digital item. If the borrower is not connected to the internet at all, then their request to use the digital content cannot be verified, and therefore the borrower will not be given access until they have connected to the server in order to establish that they still have access to the lent eBook.

The system tracks and maintains the DRM in the event that the borrower has been verified as having access to the eBook at the time the borrower opens the eBook, but then disconnects from the internet while continuing to use the eBook. This is resolved when the borrower is connected to a network and viewing the eBook through a browsing program, as the platform will be informed immediately by the server if the borrower has disconnected. In that event, the borrower will no longer have access to the eBook.

If the borrower is not connected to a network, the owner may take back the lent eBook to use or give to another borrower. However, it may be possible for the first borrower to block synchronization of the client device to the system. If this happens then the system will be out of synchronization with the first user's client device and the first borrower may continue to use the borrowed ebook. However, the system will synchronize when the first borrower has reconnected to the system and attempts to borrow additional content. If a borrower does not return a digital copy of a lent item, their profile will be marked as a non-returner, and much like a borrower from a library cannot borrow books until they return overdue books, the borrower will be prevented from requesting to borrow any further items until the previous eBook has been returned to the owner. The original lender will be given rights to download the ebook and lend to someone else, and the borrower who did not return the item will be barred from borrowing. In the preferred embodiment, there is an embedded timer within the loaned digital content which checks to see if the owner of the eBook has chosen to take back the loaned eBook. This timer will try to connect to the server a given number of times, and if the server cannot be connected to after the given number is reached, the platform will determine the borrower has chosen to remain off a network in order to retain the borrowed digital content. The borrower will be informed that they must reconnect to a network in order to determine if the borrower still has access to the lent digital content. The system will then exit out of the eBook reader software so the borrower is unable to use the digital content until confirmation is provided by the server that the borrower has access to the digital content.

Likewise, the system will be able to determine when the device has Internet, Wi-Fi, Bluetooth, or some other form of network connection that will allow the system to communicate with the server to determine if the borrower should continue to have access to the loaned digital content. If the server reply determines that the lender has taken back the digital content and has chosen to no longer loan it to the borrower, then the system will automatically deny the borrower the use of the loaned digital content, with the option to allow the borrower to again request the use of the digital content from the lender.

The system can also give a specific period of time for the lender to respond, or detect if the lender has lent the digital content to another borrower, and inform the previous borrower that the material is not currently accessible, and present other lenders within the borrower's expanded network with the same or similar digital content for the borrower to request. Simultaneously, the copy of the eBook that resides on the borrower's local client device will have a permanent block placed on it or it will be deleted so that the borrower cannot regain access to the digital content.

The invention is directed toward a method for sharing digital content comprising enrolling a first user in a social networking system, allowing the first user to search for digital content owned by other users, displaying additional users within the first user's social network that own digital content and can potentially lend the digital content to the first user, transmitting a lending request for digital content owned by a second user from the first user to the second user, receiving an acceptance from the second user, and allowing the first user to access the digital content. The method may further comprise hosting digital content owned by users of the social networking system on a server computer accessible through a network connection. The method may further comprise allowing a user of the system to view multiple levels of social connections and degrees of separation of the first user to other users of the system. In a further embodiment of the invention the first user is associated with the second user via a chain of person-to-person connections, each person-to-person connection established via the social networking system. The method may further comprise allowing the second user of the system to set the level of social connection and degree of separation of the first user to be permitted to borrow digital content owned by the second user and displaying search results to the first user based on the level of social connection and degree of separation permission set by the second user. The method may further comprise allowing only one user to access and view a digital content file at any one instant. In this embodiment the second user retains all ownership rights over the digital content loaned to the first user. The method may further comprise permitting the first user to search for digital content to borrow based on digital content name, author, category, subject, class, and school of attendance shared by the first user and the second user and permitting the first user to browse digital content available for borrowing through the first user's expanded social network. The method may further comprise denying access to the digital content to the first user upon recall of lent digital content by the second user. Furthermore, in this embodiment the digital content may be an electronic book.

In another embodiment of the invention, the invention is directed toward a method for sharing digital content comprising enrolling a first user in a social networking system, allowing the first user to search for digital content owned by other users, displaying additional users within the first user's social network that own digital content and can potentially lend the digital content to the first user, transmitting a lending request for digital content owned by a second user from the first user to the second user, receiving an acceptance from the second user, allowing the first user to access the digital content, and transferring the digital content from a second user client device to a first user client device. Furthermore, in this embodiment, the transferring is effectuated by means of wireless communication. The wireless communication may take place by any standard wireless means such as Near Field Communication (NFC), Bluetooth connection, WiFi, or any other commonly used and known means of wireless communication.

In another embodiment of the invention, the invention is directed toward a method for sharing digital content comprising enrolling a first user in a social networking system, allowing the first user to search for digital content owned by other users, displaying additional users within the first user's social network that own digital content and can potentially lend the digital content to the first user, transmitting a lending request for digital content owned by a second user from the first user to the second user, receiving an acceptance from the second user, allowing the first user to access the digital content, permitting the second user to create second user digital annotations to the digital content, permitting the first user to view the second user digital annotations, and permitting the first user to create first user digital annotations to the digital content. The first user digital annotations are viewable to the first user only when the first user has access to the digital content. The second user digital annotations are viewable to the second user only when the second user has access to the digital content. Furthermore, in this embodiment, the first user digital annotations are saved as a data file to a database connected to a server computer, the first user digital annotations are directly associated with the first user's user ID, the second user digital annotations are saved as a data file to a database connected to a server computer, the second user digital annotations are directly associated with the second user's user ID, and the second user digital annotations are not viewable to the first user unless the second user has granted the first user permission to view the second user digital annotations. This method may further comprise permitting the second user to view the first user digital annotations. In this embodiment the first user digital annotations are not viewable to the second user unless the first user has granted the second user permission to view the first user digital annotations.

The method may further comprise permitting the first user to view the first user digital annotations upon first user's purchase of ownership rights to the digital content, hosting digital content owned by users of the social networking system on a server computer accessible through a network connection, allowing a user of the system to view multiple levels of social connections and degrees of separation of the first user to other users of the system, allowing the second user of the system to set the level of social connection and degree of separation of the first user to be permitted to borrow digital content owned by the second user, displaying search results to the first user based on the level of social connection and degree of separation permission set by the second user, allowing only one user to access and view a digital content file at any one instant, permitting the first user to search for digital content to borrow based on digital content name, author, category, subject, class, and school of attendance shared by the first user and the second user, permitting the first user to browse digital content available for borrowing through the first user's expanded social network, and denying access to the digital content to the first user upon recall of lent digital content by the second user. In this embodiment the first user is associated with the second user via a chain of person-to-person connections, each person-to-person connection established via the social networking system, the second user retains all ownership rights over the digital content loaned to the first user, and the digital content is an electronic book.

The invention is also directed toward a method for sharing digital content comprising enrolling a first user in a social networking system, allowing the first user to search for digital content owned by other users, displaying additional users within the first user's social network that own digital content and can potentially lend the digital content to the first user, transmitting a loan offer from the second user to the first user, receiving an acceptance from the first user, and allowing the first user to access the digital content. In this method the second user owns rights to digital content and the second user offers to loan digital content to the first user. The method may further comprise hosting digital content owned by users of the social networking system on a server computer accessible through a network connection, allowing a user of the system to view multiple levels of social connections and degrees of separation of the first user to other users of the system, allowing the second user of the system to set the level of social connection and degree of separation of the first user to be permitted to borrow digital content owned by the second user, displaying search results to the first user based on the level of social connection and degree of separation permission set by the second user, allowing only one user to access and view a digital content file at any one instant, permitting the first user to search for digital content to borrow based on digital content name, author, category, subject, class, and school of attendance shared by the first user and the second user, permitting the first user to browse digital content available for borrowing through the first user's expanded social network, and denying access to the digital content to the first user upon recall of lent digital content by the second user. In this embodiment the first user is associated with the second user via a chain of person-to-person connections, each person-to-person connection established via the social networking system. The second user retains all ownership rights over the digital content loaned to the first user and the digital content is an electronic book.

The invention is also directed toward a system for lending digital content. The system comprises a server computer, a database connected to the server computer, an interface software module, a social networking software module and a content management software module. In this system digital content files owned by users of the system are stored in the database and the digital content files are directly associated with the user profile of the user having ownership rights of the digital content file. The interface software module provides an interface between the server and a client computing device and is hosted on the server computer. The social networking software module connects to a user's existing social network through a third party service and is hosted on the server computer. The social networking module permits a user to create a new social network. The social networking software module permits the direct association of multiple users and tracks the extended social level connection of multiple users who are not directly associated. The content management application directly controls digital files owned by a specific user and the access and viewing of the digital files and is hosted on the server computer.

The system may further comprise one or more client computers and a user annotation software module. The client computers are connected to the server computer through a network connection. The user annotation software module permits a user to add annotations and comments to specific digital content. The annotations and comments are stored in a data file associated with the specific digital content. The data file is directly associated with a user profile.

### BRIEF DESCRIPTION OF THE DRAWINGS

FIG. 1 is a schematic view of the system

FIG. 2 is a schematic view of the system

FIG. 3 is a schematic view of a user's search results

FIG. 4 is a schematic view of the borrowing process utilized by a borrower

FIG. 5 is a schematic view of the lending process utilized by a lender

FIG. 6 is a schematic view of the process of adding and viewing digital annotations

### DETAILED DESCRIPTION OF THE DRAWINGS

Although the present invention will be described with reference to the exemplary embodiments shown in the drawings, it should be understood that the present invention can be embodied in many alternate forms or embodiments.

It should be understood that the description of the invention will utilize the term “ebook” for simplicity of the description and notifying the preferred embodiment of the invention. However, the invention is directed toward the sharing of any and all types of digital content. Such digital content includes ebooks, text files, audio files, video files, and any other type of electronic content or data.

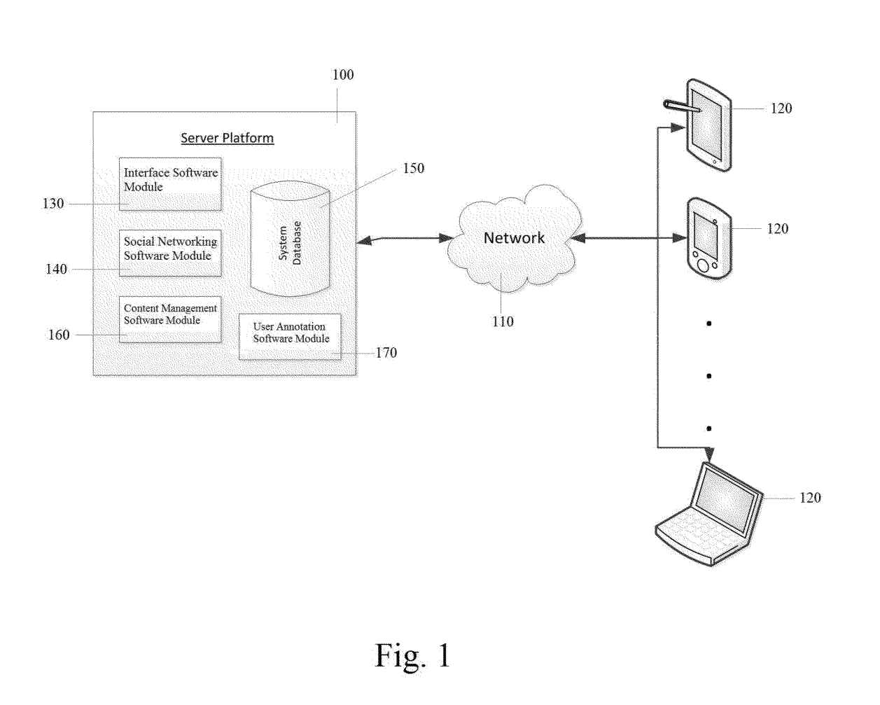

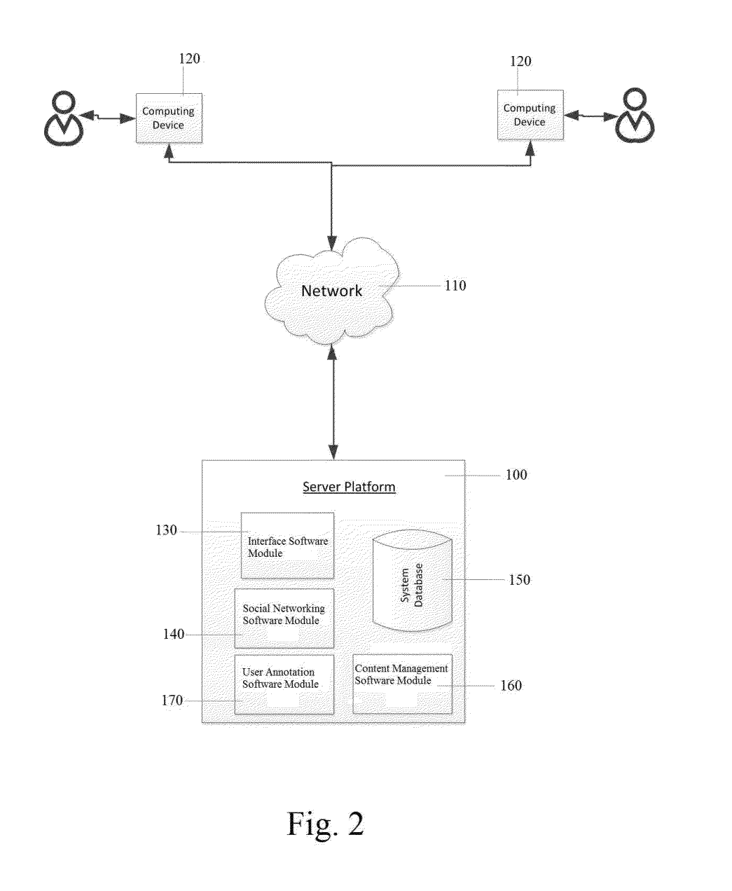

Referring to FIG. 1 and FIG. 2, the system is comprised of a server computer 100 and a client computer 120 connected through a network connection 110. Those having skill in the art would appreciate that the functions performed by the server computer 100 could entail only one server computer 100 or, alternatively, more than one server computer 100 working in tandem. A database 150 is connected to the server computer 100. Hosted on the server computer is an interface software module 130, a social networking software module 140, and a content management software module 160. In the embodiment of the invention displayed the server computer 100 also hosts a user annotation software module 170. As shown in FIG. 1, the system may be used by an individual on any type of client computer 120, including a tablet computer, a web enabled cellular phone, or a laptop. As shown in FIG. 2, a first user may use the system on the first user's client computer 120 to connect with and transfer digital content to a second user on the second user's client computer 120.

The interface software module 130 allows a user to create a unique password protected user ID. Information about the user, including contact information, is stored on the server computer 100 in connection with the user's user ID. The user may then purchase the master rights to any digital ebook. The master digital file of the digital ebook is stored on the server computer 100 in the system database 150. Alternatively, the user may upload digital files to the system for storage of ebooks for which the user has already purchased full rights. In this way, the user creates a personal digital library which is stored on the system database 150. When a user desires to read an ebook that is stored on the system database 150, the user accesses the digital file from a client computer 120 or device. The client computer 120 can be any web enabled computing device such as a laptop computer, desktop computer, e-reader, tablet computer, PDA, smart phone or other computing device that allows for the display of eBooks. The user may read the ebook through a web browser without downloading the digital file to the client computer. Alternatively, the user may download a copy of the digital file to the client computer 120 and read the ebook through a viewer program.

The system also entails a user annotation software module 170 which allows the user to add annotations or comments to the digital ebook. This process is desirable when a user is reading an ebook for educational purposes or if the user is reading the ebook as part of a book club. The user may highlight text in the ebook. The user may add comments, notes, or multimedia annotations to particular parts of the text in the margins of the ebook. Multimedia annotations can take the form of images, videos, audio, 3D files (for use with a 3D printer), attached documents, and other files. The annotations are saved on the server computer 100 in connection with the ebook and the user ID. When the user later accesses the ebook, any saved annotations and comments are displayed with the ebook for the user to review.

The system also entails a software networking software module 140 allowing users of the system to become linked together into a social network where the users are displayed in degrees of separation, or to connect using an existing social network, such as Facebook, LinkedIn, Twitter, Google Plus, etc.

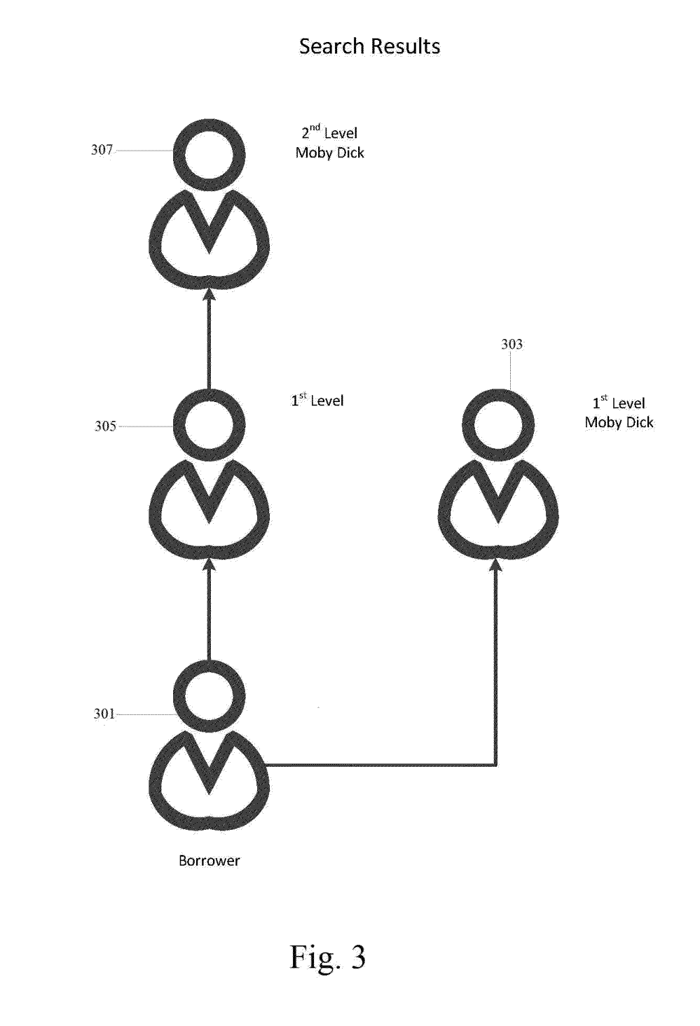

FIG. 3 demonstrates a sample of search results that a first user 301 may view when searching for a specific digital content file through the first user's 301 social network. The first user may search for those users within the first user's 301 expanded social network who own the title Moby Dick. The first user 301 may find a second user 303 who is a first level connection of the first user 301. The first user 301 can see that the second user 303 owns the title Moby Dick and that the second user 303 has indicated that the title is available for borrowing. The first user 301 may then send a loan request to the second user 303. If the second user 303 has indicated that the title is not available for other users to borrow, the first user 301 may look for other users within the first user's 301 expanded social network who own the title Moby Dick and have indicated that the title is available for others to borrow. The first user may find that a fourth user 307 owns the title Moby Dick and has indicated that the titled is available for others to borrow. The fourth user 307 is a second level social connection with the first user 301. The fourth user 307 is not a direct connection to the first user 301, but is instead a “friend of a friend.” The first user 301 is a first level connection with a third user 305, who is in turn a first level connection with the fourth user 307. This makes the fourth user 307 a second level connection with the first user 301. In this manner, the users of the system are grouped together into an expandable social network system. The system tracks the degree of connection between users such that a “friend” is a first degree connection, a “friend” of a “friend” is a second degree connection, a “friend” of a “friend” of a “friend” is a third degree connection, and so forth until all connected users are incorporated into the proper degrees of connection to a first user 301.

The content management software module 160 allows a user (lender) to lend digital content, such as ebooks, from the user's personal library to other users. The lender may lend digital ebooks from the lender's personal library to other users of the system provided that the lender has approved of such lending. The lender may decide to authorize the lending of an ebook based upon the degree of connection of other users. For instance, if the lender authorizes the lending of the ebook to first degree connections the first degree connections may borrow the ebook but second degree connections may not borrow the ebook. However, if the lender authorizes the lending of the book to second degree connections then both first degree connections and second degree connections may borrow the ebook but third degree connections may not. In a like manner, in the system if a lender becomes a borrower, the user can borrow based on the same degrees of separation as they lend. This encourages the user base to lend to others who are a greater degree of separation from the user, as it also allows the user to borrow from a potentially larger user pool.

The content management software module 160 is established such that a user may search the personal libraries of other users based upon title of the ebook, author of the ebook, name of the social connection, degree of connection, and any other parameter established by a system administrator. For example, and by no means a limitation of the system, a first user 301 (borrower) may decide that he desires to read Moby Dick. The borrower may search for the title Moby Dick. The results may display that a second user 303, who is a first degree connection, (lender) possesses Moby Dick in her personal library. The borrower may submit a loan request to the lender to borrow the Moby Dick ebook. If the lender has preauthorized the lending of the ebook to first degree connections then the ebook will become available to the borrower without any additional authorization by the lender. If the lender has not preauthorized the lending of the ebook then the borrow request is submitted to the lender. The lender may approve or decline the borrow request. If the lender has approved the borrow request then the borrower will be able to borrow the Moby Dick ebook. The Moby Dick ebook becomes unavailable to the lender during the time that the first user borrows the ebook.—The borrower may borrow Moby Dick for a predetermined period of time or for an unspecified period of time. Any time during the loan period, if the lender decides that she wants Moby Dick back, then the lender simply retracts the authorization and takes back the ebook. The ebook immediately becomes unavailable to the borrower, regardless of whether the borrower has completed the ebook or not. Additionally, the borrower may return the ebook to the lender at any time during the loan period. If the loan period is for a predetermined length of time then the system will automatically return Moby Dick to the lender upon the expiration of the length of time.

If the borrower performs a search for Moby Dick and sees that a fourth user 307, who is a second degree connection through a third user 305, has Moby Dick in her personal library, the first user 301 may see whether he is within the proper degree of connections for which the second degree connection has granted authorization to borrow the ebook. If the second degree connection has only authorized the lending of Moby Dick to first degree connections then the first user 301 will be unable to borrow the ebook unless and until the second degree connection has authorized the lending of the ebook to second degree connections. The first user 301 may still send a borrow request to the second degree connection even though the first user knows that the second degree connection has not authorized the lending of the ebook to second degree connections. The second degree connection may choose to ignore the request, connect directly with the second degree connection and thus change the connection to a first degree connection, or change the lending parameters of the ebook to allow second degree connections to borrow the ebook. In another embodiment of the invention, the second degree connection may choose to simply deny all borrow requests from those users outside of the authorized degree of connection. In this embodiment, the first user will be unable to send a borrow request to the second level connection. However, if the second degree connection has authorized the lending of Moby Dick to second degree connections then the lending process is the same as noted above.

The borrower initiates the request to be lent the digital content item(s). The borrower may see that a particular user (lender) within the borrower's social network has a particular ebook which can be lent. The borrower can then send a request through the server, or by copying a system generated message containing a URL, send that message via their established communication means, such as email, Facebook, Twitter, etc. When sent through the system, the server computer 100 informs the proposed lender that there is a borrow request waiting for them, from whom the borrow request originates, the digital item being requested, and the length of time for which the item is being requested. The request can be sent through a network 110, such as the internet or LAN, or can be sent in-person from the borrower's client computer 120 to the lender's client computer 120 via Bluetooth, Near Field Communication, WiFi, or other means that allows a device to communicate with another device that is within close proximity to the first device. The communication and sharing of the digital content can occur over a network 110, such as the internet, and can be viewed on client computing devices 120, which include but are not limited to PC, tablets, smartphones, and other computing devices that can transfer data, connect to a network, and display content for a user's consumption.

The lender views the request(s) on their local device sent through the server or in-person. When the lender accepts a particular borrower's request, the server computer 100 is informed of 1) the lender, 2) the digital item to be lent, 3) the borrower, 4) the length of time for which the digital item is being requested. The server computer 10 processes the request and grants access to the loaned digital item to the borrower, as well as sends a message to the borrower informing him that the loan request has been accepted and he can have access to the digital content. For the above, when lending an eBook, a user will be presented with more information to assist with determining to whom to lend the digital content item. For instance, the proposed borrower may be part of the lender's class, or school, or within their social network. Conversely, the borrower may be many degrees of separation and may be someone the lender has never met nor has an immediate connection to. This information is valuable, in the cases when the user is presented with multiple requests for the borrowing of digital content. In this scenario, the system will rank the requests coming from the potential borrowers based on degrees of separation, frequency of communication, past lending/borrowing, class/school/degree affiliation, and other pertinent info to rank the requests that come in.

When the end of the loan period has nearly been reached, the server computer 100 informs the borrower and lender that the requested borrowing time is nearly over, along with the amount of time remaining. When the time length is reach, the server computer 100 can either automatically remove access to the borrower, or allow access until the lender purposely removes the borrower from using the digital content item. Even if the borrower is within the length of time originally requested from the lender, the lender can take back control at any time without the consent of the borrower. The borrower cannot re-lend the digital item to another user.

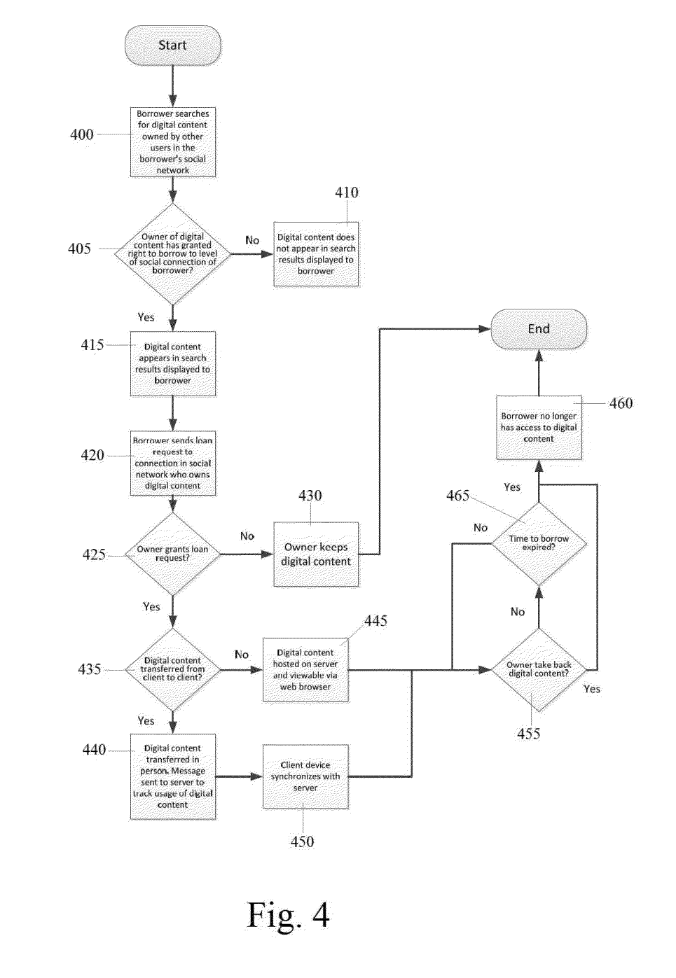

FIG. 4 demonstrates the process that the system performs when a borrower uses the system to borrow a digital content item from another user. The borrower starts by searching for digital content owned by other users within the borrower's social network 400. Next, the system determines whether the owner of the digital content has granted the right to borrow the digital content to the level of social connection which the borrower is 405. If not, then the digital content does not appear in the search results displayed to the borrower 410. If so then the digital content appears in the search results displayed to the borrower 415. Once the borrower has decided whom to borrow the digital content from, the borrower sends a loan request to the connection in the borrower's social network who owns the digital content requested 420. The owner of the digital content receives the loan request. If the owner of the digital content does not grant the loan request then the owner of the digital content keeps the digital content 430 and the borrower does not receive the digital content. If the owner of the digital content grants the loan request then the system determines whether the digital content is transferred from the owner to the borrower directly from the owner's client computer to the borrower's client computer 435. If the digital content has been transferred directly then the digital content item is transferred in person and a message is sent to the server computer to track the usage of the digital content item 440. The borrower's client device then synchronizes with the server computer 450. If the digital content is not transferred directly then the digital content is hosted on the server computer and is viewable to the borrower through a web browser program 445. The borrower receives the digital content item for a specified period of time. At any point in time the owner can take back the digital content item 455. If the owner takes back the digital content item then the borrower no longer has access to the digital content item 460. If the owner has not taken back the digital content item then the system determines whether the specified period of time for which the digital content item has been borrowed has elapsed 465. If the period of time has not elapsed then the system permits the borrower to continue to view the digital content item and the owner may still take back the digital content item at any time 455. If the period of time has elapsed then the system automatically transmits the file back to the owner of the digital content and the borrower no longer has access to the digital content file 460.

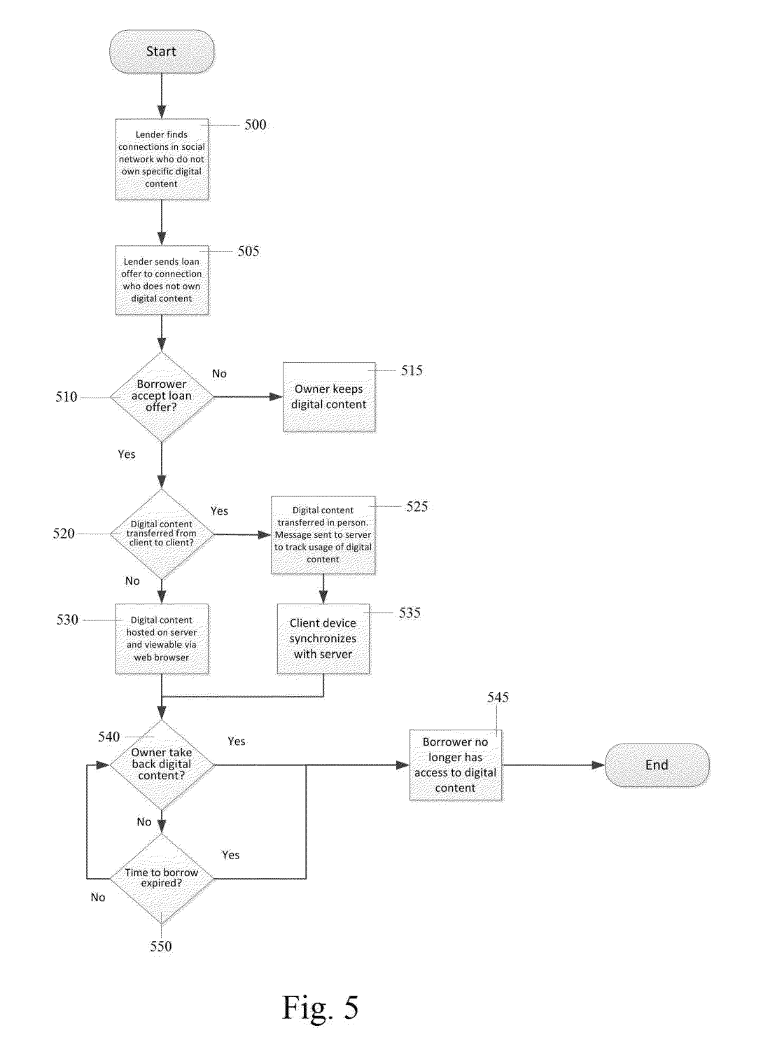

FIG. 5 displays the process that the system performs when an owner of a digital content file loans the digital content file to another user within the owner's expanded social network. A user of the system my upload digital content to the server computer 100 which is stored in the database 150. The owner of the digital content may love the digital content so much that the owner of the digital content wishes to share the digital content with others who would also love the digital content. The owner of the digital content starts by searching the system for other users within the owner's extended social network who do not own that specific digital content file 500. The owner then sends a loan offer to a social connection who does not own the digital content file 505. The borrower may then decide whether or not to accept the loan offer 510. If the borrower does not accept the loan offer then the borrower does not receive the digital content file and the owner keeps the digital content file 515. If the borrower accepts the loan offer then the system then the system determines whether the digital content is transferred from the owner to the borrower directly from the owner's client computer to the borrower's client computer 520. If the digital content has been transferred directly then the digital content item is transferred in person and a message is sent to the server computer to track the usage of the digital content item 525. The borrower's client device then synchronizes with the server computer 535. If the digital content is not transferred directly then the digital content is hosted on the server computer and is viewable to the borrower through a web browser program 530. The borrower receives the digital content item for a specified period of time. At any point in time the owner can take back the digital content item 540. If the owner takes back the digital content item then the borrower no longer has access to the digital content item 545. If the owner has not taken back the digital content item then the system determines whether the specified period of time for which the digital content item has been borrowed has elapsed 550. If the period of time has not elapsed then the system permits the borrower to continue to view the digital content item and the owner may still take back the digital content item at any time 540. If the period of time has elapsed then the system automatically transmits the file back to the owner of the digital content and the borrower no longer has access to the digital content file 545.

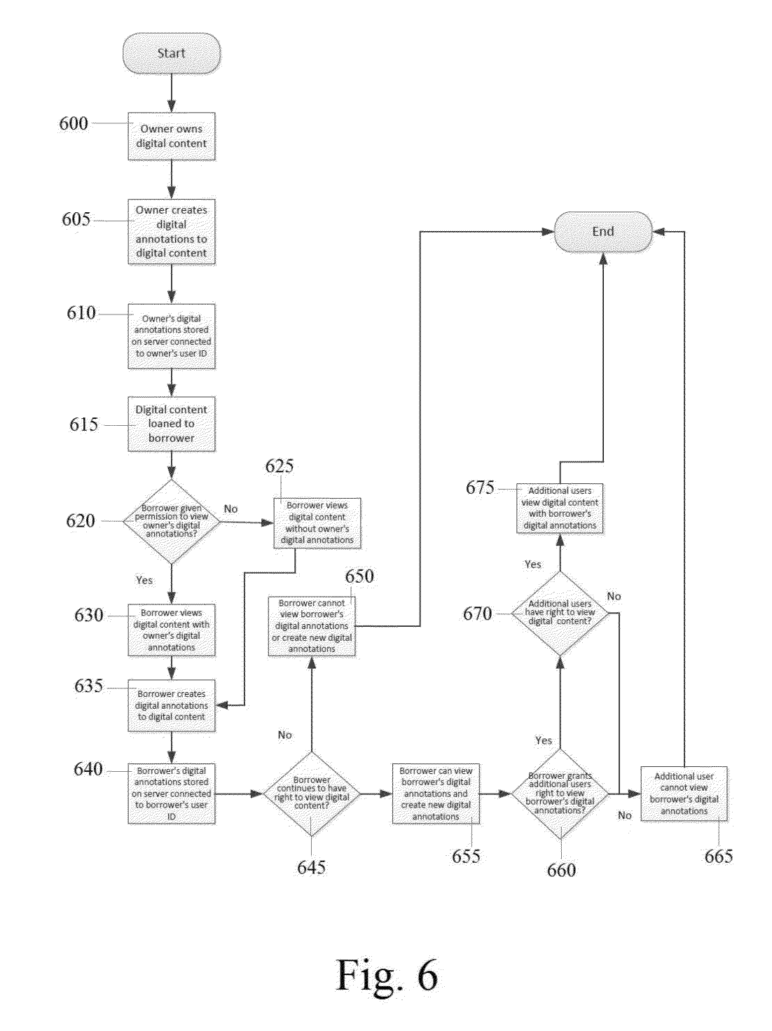

FIG. 6 displays the method that the system performs when a user creates and shares digital annotations that are associated with a specific digital content file. The system starts when an owner owns a digital content file that is stored on the server computer database 600. The owner can then create digital annotations to the digital content file 605. The owner's digital annotations are stored on the server and are connected to the owner's user ID 610. Next the owner of the digital content file loans the digital content file to a borrower 615. Next, the system determines whether the owner has given the borrower the permission to view the owner's digital annotations in addition to the digital content file 620. If not, then the borrower views the digital content file without the owner's digital annotations 625. Of the borrower does have permission to view the digital annotations then the borrower views the digital content file with the owner's digital annotations 630. Regardless of whether the borrower has the permission to view the owner's digital annotations or not, the borrower may create his own digital annotations to the borrowed digital content 635. The borrower's digital annotations are stored on the server computer and are connected to the borrower's user ID 640. The system then determines whether the borrower continues to have the right to view the digital content file 645, such as when the time for which the file was borrowed has elapsed or if the owner has taken back the digital content file. If the borrower no longer has the right to view the digital content file then the borrower cannot view the borrower's digital annotations and cannot create new digital annotations 650. If the borrower does continue to have the right to view the digital content file then the borrower can view the borrower's digital annotations and can create new digital annotations 655. The system then determines whether the borrower has granted other users of the system the right to view the borrower's digital annotations 660. If the borrower has not granted other users the right to view the borrower's digital annotations then the other users cannot view the borrower's digital annotations 665. If the borrower has granted other users the right to view the borrower's digital annotations then the system determines whether the other users have the right to view the digital content file to which the digital annotations apply 670. If the other users do not have the right to view the digital content file, perhaps because they have not borrowed the digital content file from another owner or do not own the digital file themselves, then the other users cannot view the borrower's digital annotations 665. If the other users do have the right to view the digital content file then the other users can view the digital content with the borrower's digital annotations 675.

1. A method for sharing digital content comprising:
Enrolling a first user in a social networking system
Allowing said first user to search for digital content owned by other users
Displaying additional users within said first user's social network that own digital content and can potentially lend said digital content to said first user;
Transmitting a lending request for digital content owned by a second user from said first user to said second user
Receiving an acceptance from said second user
Allowing said first user to access said digital content.

2. The method as in claim 1 further comprising
Hosting digital content owned by users of said social networking system on a server computer accessible through a network connection.

3. The method as in claim 2 further compromising:
Allowing a user of the system to view multiple levels of social connections and degrees of separation of said first user to other users of the system.

4. The method as in claim 3 further compromising:
Wherein said first user is associated with said second user via a chain of person-to-person connections, each person-to-person connection established via the social networking system.

5. The method as in claim 4 further compromising:
Allowing said second user of the system to set the level of social connection and degree of separation of said first user to be permitted to borrow digital content owned by said second user
Displaying search results to said first user based on the level of social connection and degree of separation permission set by said second user.

6. The method as in claim 5 further compromising:
Allowing only one user to access and view a digital content file at any one instant
Wherein said second user retains all ownership rights over said digital content loaned to said first user

7. The method as in claim 6 further compromising:
Permitting said first user to search for digital content to borrow based on digital content name, author, category, subject, class, and school of attendance shared by said first user and said second user
Permitting said first user to browse digital content available for borrowing through said first user's expanded social network.

8. The method as in claim 7 further comprising
Denying access to said digital content to said first user upon recall of lent digital content by said second user

9. The method as in claim 8 wherein the digital content is an electronic book

10. The method as in claim 1 further comprising transferring said digital content from a second user client device to a first user client device

11. The method as in claim 10 wherein said transferring is effectuated by means of wireless communication

12. The method as in claim 1 further comprising
Permitting said second user to create second user digital annotations to said digital content
Permitting said first user to view said second user digital annotations
Permitting said first user to create first user digital annotations to said digital content
Wherein said first user digital annotations are viewable to said first user only when said first user has access to said digital content
Wherein said second user digital annotations are viewable to said second user only when said second user has access to said digital content

13. The method as in claim 12 further compromising:
Wherein said first user digital annotations are saved as a data file to a database connected to a server computer;
Wherein said first user digital annotations are directly associated with said first user's user ID
Wherein said second user digital annotations are saved as a data file to a database connected to a server computer
Wherein said second user digital annotations are directly associated with said second user's user ID
Wherein said second user digital annotations are not viewable to said first user unless said second user has granted said first user permission to view said second user's digital annotations.

14. The method as in claim 13 further compromising:
Permitting said second user to view said first user digital annotations
Wherein said first user digital annotations are not viewable to said second user unless said first user has granted said second user permission to view said first user digital annotations.

15. The method as in claim 14 further compromising:
Permitting said first user to view said first user digital annotations upon first user's purchase of ownership rights to said digital content

16. The method as in claim 15 further comprising
Hosting digital content owned by users of said social networking system on a server computer accessible through a network connection
Allowing a user of the system to view multiple levels of social connections and degrees of separation of said first user to other users of the system
Wherein said first user is associated with said second user via a chain of person-to-person connections, each person-to-person connection established via the social networking system
Allowing said second user of the system to set the level of social connection and degree of separation of said first user to be permitted to borrow digital content owned by said second user
Displaying search results to said first user based on the level of social connection and degree of separation permission set by said second user
Allowing only one user to access and view a digital content file at any one instant
Wherein said second user retains all ownership rights over said digital content loaned to said first user
Permitting said first user to search for digital content to borrow based on digital content name, category, subject, class, and school of attendance shared by said first user and said second user
Permitting said first user to browse digital content available for borrowing through said first user's expanded social network.
Denying access to said digital content to said first user upon recall of lent digital content by said second user
wherein the digital content is an electronic book

17. A method for sharing digital content comprising
Enrolling a first user in a social networking system
Allowing said first user to search for digital content owned by other users
Displaying additional users within said first user's social network that own digital content and can potentially lend said digital content to said first user;
Transmitting a loan offer from said second user to said first user
Wherein said second user owns rights to digital content
Wherein said second user offers to loan digital content to said first user
Receiving an acceptance from said first user
Allowing said first user to access said digital content.

18. The method as in claim 17 further comprising
Hosting digital content owned by users of said social networking system on a server computer accessible through a network connection
Allowing a user of the system to view multiple levels of social connections and degrees of separation of said first user to other users of the system
Wherein said first user is associated with said second user via a chain of person-to-person connections, each person-to-person connection established via the social networking system
Allowing said second user of the system to set the level of social connection and degree of separation of said first user to be permitted to borrow digital content owned by said second user
Displaying search results to said first user based on the level of social connection and degree of separation permission set by said second user
Allowing only one user to access and view a digital content file at any one instant
Wherein said second user retains all ownership rights over said digital content loaned to said first user
Permitting said first user to search for digital content to borrow based on digital content name, category, subject, class, and school of attendance shared by said first user and said second user
Permitting said first user to browse digital content available for borrowing through said first user's expanded social network.
Denying access to said digital content to said first user upon recall of lent digital content by said second user
Wherein the digital content is an electronic book

19. A system for lending digital content comprising:
A server computer
A database connected to said server computer
Wherein digital content files owned by users of the system are stored in said database
Wherein said digital content files are directly associated with the user profile of the user having ownership rights of the digital content file
An interface software module
Wherein said interface software module provides an interface between said server and a client computing device
Wherein said interface software module is hosted on said server computer
A social networking software module
Wherein said social networking software module is hosted on said server computer
Wherein said social networking module connects to a user's existing social network through a third party service
Wherein said social networking module permits a user to create a new social network
Wherein said social networking software module permits the direct association of multiple users and tracks the extended social level connection of multiple users who are not directly associated
A content management software module
Wherein said content management software module is hosted on said server computer
Wherein said content management application directly controls digital files owned by a specific user and the access and viewing of said digital files.

20. The system as in claim 19 further comprising
One or more client computers
Wherein said client computers are connected to said server computer through a network connection
A user annotation software module
Wherein said user annotation software module permits a user to add annotations and comments to specific digital content
Wherein said annotation and comments are stored in a data file associated with said specific digital content
Wherein said data file is directly associated with a user profile
